(19) United States
(12) Patent Application Publication
(10) Pub. No.: US 2022/0315701 A1
(43) Pub. Date: Oct. 6, 2022

(54) COPOLYMERS WITH HARD POLYAMIDE BLOCKS AND SOFT BLOCKS COMPRISING POLYETHYLENE GLYCOL

(71) Applicant: Arkema France, Colombes (FR)

(72) Inventors: Quentin PINEAU, Serquigny (FR); Clio COCQUET, Serquigny (FR); Helena CHEMINET, Wauwatosa, WI (US); Claude-Olivier BOISSIERE, Serquigny (FR)

(73) Assignee: Arkema France, Colombes (FR)

(21) Appl. No.: 17/627,142

(22) PCT Filed: Jul. 15, 2020
(86) PCT No.: PCT/FR2020/051272

§ 371 Date: Jan. 14, 2022

(30) Foreign Application Priority Data
Jul. 15, 2019 (FR) 1907933

(51) Int. Cl. C08G 69/44; C08G 81/00; B01D 53/22; C08J 5/18

(52) U.S. Cl. CPC C08G 69/44; C08G 81/00; B01D 53/228; C08J 5/18

(57) ABSTRACT

A method relating to a copolymer containing rigid polyamides blocks and flexible blocks including, relative to the total weight of the copolymer: from 55% to 90% by weight of flexible blocks, including at least 35% by weight from polyethylene glycol; from 10% to 45% by weight of rigid polyamide blocks, in which the mean carbon content of the repeating units of the polyamide blocks is greater than or equal to 7. A method also relating to a process for preparing such a copolymer, to a membrane including such a copolymer and to a process for preparing such a membrane.

### FIELD OF THE INVENTION

The present invention relates to a copolymer containing rigid polyamide blocks and flexible blocks, to a process for preparing such a copolymer and also to a membrane formed from this copolymer.

### TECHNICAL BACKGROUND

Greenhouse gas emissions and their effects on global warming have become a major concern. Various technologies have been developed to recover the gases responsible for the greenhouse effect, such as carbon dioxide and methane. Among these, polymeric gas separation membranes are under development due to their lower environmental impact. Gas separation membranes can also be used for many other applications, for example for the purification of natural gas or in new enthalpy heat exchangers.

WO 2018/222255 describes a gas separation process using a membrane comprising a crosslinked mixture of a polyetheramide copolymer and an acrylate-terminated polyethylene glycol.

The article by Scholes et al., Crosslinked PEG and PEBAX Membranes for Concurrent Permeation of Water and Carbon Dioxide, Membranes, volume 6, number 1, 0001 (2016), describes membranes of a copolymer containing blocks derived from PTMG and polyamide blocks or blocks of a crosslinked polyethylene glycol diacrylate.

The article by Car et al., PEG modified poly(amide-b-ethylene oxide) membranes for CO₂ separation, Journal of Membrane Science, volume 307, pages 88-95 (2008), describes membranes prepared from a copolymer blend containing polyamide 6 blocks and blocks derived from polyethylene glycol and polyethylene glycol.

The article by Alqaheem et al., Polymeric Gas-Separation Membranes for Petroleum Refining, International Journal of Polymer Science, volume 2017, number 117, pages 1-19 (2017), studies various polymer membranes and their permeability to several gases.

The article by Bondar et al., Gas Transport Properties of Poly(ether-b-amide) Segmented Block Copolymers, Journal of Polymer Science: Part B: Polymer Physics, volume 38, number 15, pages 2051-2062 (2000), relates to membranes of copolymers containing polyamide blocks and polyether blocks.

In certain applications, it is desirable to use membranes that are highly permeable to water vapor and to carbon dioxide but sparingly permeable to dioxygen. In enthalpy heat exchangers, the polymer membranes used must be permeable to water vapor while at the same time being impermeable to VOCs (volatile organic compounds). Liquid desiccant air conditioning applications may also require the use of a membrane that is permeable to water vapor to dehydrate the air before cooling it.

Increasing the permeability of membranes to water vapor and carbon dioxide can be achieved by increasing the hydrophilicity of the polymer. However, the water uptake is also greatly increased, which leads to degradation of the mechanical properties of the membrane in the water-saturated state.

There is thus a need to provide polymers that are useful for the preparation of gas separation membranes having waterproof-breathable properties and also good permeability to carbon dioxide and low permeability to dioxygen, while at the same time conserving sufficient mechanical properties in the wet state.

### SUMMARY OF THE INVENTION

The invention relates firstly to a copolymer containing rigid polyamides blocks and flexible blocks comprising, relative to the total weight of the copolymer:
from 55% to 90% by weight of flexible blocks, including at least 35% by weight from polyethylene glycol;
from 10% to 45% by weight of rigid polyamide blocks, in which the mean carbon content of the repeating units of said polyamide blocks is greater than or equal to 7.

According to certain embodiments, the flexible blocks are polyether blocks and/or polyether and polyester blocks.

According to certain embodiments, the flexible blocks are blocks derived from polyethylene glycol.

According to certain embodiments, the flexible blocks comprise, in addition to blocks derived from polyethylene glycol, blocks derived from another polyether, such as polytetrahydrofuran and/or propylene glycol, and/or polyester.

According to certain embodiments, the mean carbon content of the repeating units of the polyamide blocks is from 8 to 14, preferably from 8 to 12.

According to certain embodiments, the rigid polyamide blocks are blocks of polyamide 11, polyamide 12, polyamide 6.10, polyamide 6.12, polyamide 10.10, polyamide 10.12, copolyamide 6/11, copolyamide 6/12, copolyamide 11/12 or mixtures, or copolymers, thereof.

According to certain embodiments, the copolymer comprises from 56% to 90%, preferably from 57%, from 58% or from 59% to 90% by weight of flexible blocks, relative to the total weight of the copolymer.

According to certain embodiments, the copolymer comprises from 10% to 44%, preferably from 10% to 43%, or from 10% to 42%, or from 10% to 41% by weight of rigid polyamide blocks, relative to the total weight of the copolymer.

According to certain embodiments, the copolymer comprises from 60% to 90% by weight of flexible blocks and from 10% to 40% by weight of rigid polyamide blocks, relative to the total weight of the copolymer.

According to certain embodiments, the copolymer comprises at least 40% by weight of flexible blocks derived from polyethylene glycol, preferably from 50% to 90% by weight, or from 55% to 90%, or from 56% to 90%, more preferentially from 60% to 80% by weight, relative to the total weight of the copolymer.

According to certain embodiments, the copolymer is a copolymer containing polyamide 11 blocks and blocks derived from polyethylene glycol, a copolymer containing polyamide 11 blocks and blocks derived from polyethylene glycol and blocks derived from polytetrahydrofuran, a copolymer containing polyamide 12 blocks and blocks derived from polyethylene glycol, a copolymer containing polyamide 12 blocks and blocks derived from polyethylene glycol and blocks derived from polytetrahydrofuran, a copolymer containing copolyamide 6/11 blocks and blocks derived from polyethylene glycol or a copolymer containing copolyamide 6/11 blocks and blocks derived from polyethylene glycol and blocks derived from polytetrahydrofuran.

According to certain embodiments, the copolymer has an elongation at break in the water-saturated state of greater than or equal to 100%, preferably greater than or equal to 200%, more preferably greater than or equal to 300%.

According to certain embodiments, the copolymer has a water absorption to saturation at 23° C. ranging from 50% to 160% by weight, preferably from 50% to 150% by weight, relative to the total weight of the copolymer.

The invention also relates to a membrane comprising a copolymer as described above.

According to certain embodiments, the membrane is waterproof-breathable.

According to certain embodiments, the membrane has a selectivity, defined as the ratio of its permeability to carbon dioxide to its permeability to dioxygen, measured at a temperature of 23° C. and at 0% relative humidity, of greater than or equal to 10, preferably greater than or equal to 12.

According to certain embodiments, the membrane has a permeability to water vapor MVTR of at least 800 g/m², preferably at least 900 g/m², more preferably at least 1000 g/m², more preferentially from 1000 to 5000 g/m², per 24 hours, at 23° C., for a relative humidity level of 50% and a membrane thickness of 30 μm.

According to certain embodiments, the membrane has a thickness of from 0.05 to 100 μm, preferably from 0.5 to 50 μm.

According to certain embodiments, the membrane also comprises at least one polymer or oligomer chosen from polyolefins such as polyethylene, polypropylene, poly(3-methyl-1-butene) and poly(4-methyl-1-pentene); vinyl polymers such as polystyrene, poly(methyl methacrylate); polysulfones; fluorinated or chlorinated polymers such as poly(vinylidene fluoride), polytetrafluoroethylene, fluorovinylethylene/tetrafluoroethylene copolymers, polychloroprene; polyamides such as PA 6, PA 6.6 and PA 12; copolymers containing rigid blocks and flexible blocks, such as copolymers containing polyamide blocks and polyether blocks; polyesters such as polyethylene terephthalate, polybutene terephthalate and polyethylene-2,6-naphthalate; polycarbonates such as poly-4,4′-dihydroxydiphenyl-2,2-propane carbonate; polyethers such as polyoxymethylene and polymethylene sulfide; polyphenylene chalcogenides such as polythioether, polyphenylene oxide and polyphenylene sulfide; polyether ether ketones; polyether ketone ketones; silicones such as polyvinyltrimethylsiloxane, polydimethylsiloxane, perfluoroalkoxy; polyethylene glycol; ethylene-vinyl acetate; ethylene-methyl acrylate; ethylene-(ethylene-butyl acrylate)-maleic anhydride, ethylene-(ethylene-methyl acrylate)-maleic anhydride, ethylene-glycidyl methacrylate-(ethylene-butyl acrylate), ethylene-(ethylene-methyl acrylate)-glycidyl methacrylate, ethylene-(ethylene-vinyl acetate)-maleic anhydride terpolymers; and mixtures thereof.

The invention also relates to the use of a copolymer as described above, for the manufacture of a gas separation membrane, or of a membrane for dehumidifying gases, for example air, or an enthalpy heat exchanger membrane, or a textile membrane.

According to certain embodiments, the gas separation membrane is a greenhouse gas recovery membrane.

The invention also relates to a process for preparing a copolymer as described above, comprising the following steps:
the synthesis of the rigid polyamide blocks from polyamide precursors;
the addition of the flexible blocks;
condensation of the rigid polyamide blocks and of the flexible blocks.

The invention also relates to a process for preparing a copolymer as described above, involving mixing the flexible blocks with polyamide precursors and a chain-limiting diacid.

The invention also relates to a process for manufacturing a membrane as described above, comprising the following steps:
supplying a copolymer as described above;
dissolving the copolymer in a solvent;
depositing the polymer dissolved in the solvent on a substrate;
evaporating off the solvent.

The invention also relates to a process for manufacturing a membrane as described above, comprising the following steps:
supplying a copolymer as described above;
melting the copolymer;
forming a molten copolymer film;
solidifying the film.

The present invention meets the need expressed above. It more particularly provides copolymers which can be used for the preparation of membranes, said membranes having high permeability to water vapor and to carbon dioxide. Said membranes also show, inter alia, high selectivity toward carbon dioxide relative to dioxygen while at the same time maintaining good mechanical properties in the wet state and good durability.

This is accomplished by means of a copolymer comprising a particular proportion of rigid polyamide blocks, of flexible blocks and of blocks derived from polyethylene glycol and in which the polyamide has repeating units with a mean carbon content greater than or equal to a minimum value.

According to certain particular embodiments, the invention also has one or preferably several of the advantageous features listed below: waterproof-breathable properties, high selectivity toward water vapor relative to other gases, good selectivity toward carbon dioxide relative to dinitrogen, good selectivity toward hydrogen sulfide relative to methane, good selectivity toward VOCs relative to dinitrogen.

### BRIEF DESCRIPTION OF THE FIGURES

FIG. 1 shows the tensile curves in the transverse direction relative to extrusion obtained for PEBA No. 3 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

FIG. 2 shows the tensile curves in the longitudinal direction relative to extrusion obtained for PEBA No. 3 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

FIG. 3 shows the tensile curves in the transverse direction relative to extrusion obtained for PEBA No. 2 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

FIG. 4 shows the tensile curves in the longitudinal direction relative to extrusion obtained for PEBA No. 2 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

FIG. 5 shows the tensile curves in the transverse direction relative to extrusion obtained for PEBA No. 7 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

FIG. 6 represents the tensile curves in the longitudinal direction relative to extrusion obtained for PEBA No. 7 described in Example 1. The elongation, in mm, is given on the x-axis and the stress, in MPa, on the y-axis. The black curve represents the tensile curve obtained before the MVTR measurement test and the gray curve represents the tensile curve obtained after the MVTR measurement test.

### DETAILED DESCRIPTION

The invention is now described in greater detail and in a nonlimiting manner in the description that follows.

Unless otherwise indicated, all the percentages are mass percentages.

The invention relates to a copolymer containing rigid blocks and flexible blocks. These copolymers are thermoplastic elastomer (TPE) polymers comprising blocks that are rigid (or hard, with rather thermoplastic behavior) and blocks that are flexible (or soft, with rather elastomeric behavior).

The term “rigid block” means a block which has a melting point or a glass transition temperature of greater than 20° C. (in the case of amorphous blocks). The presence of a melting point may be determined by differential scanning calorimetry, according to the standard ISO 11357-3 Plastics—Differential scanning calorimetry (DSC) Part 3.

The term “flexible block” means a block with a glass transition temperature (Tg) of less than or equal to 0° C. The glass transition temperature may be determined by differential scanning calorimetry, according to the standard ISO 11357-2 Plastics—Differential scanning calorimetry (DSC) Part 2. The rigid blocks of the copolymer according to the invention are polyamide blocks.

Three types of polyamide blocks may advantageously be used.

According to a first type, the polyamide blocks originate from the condensation of a dicarboxylic acid, in particular those containing from 4 to 36 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), para-aminodicyclohexylmethane (PACM), isophoronediamine (IPDA), 2,6-bis(aminomethyl)norbornane (BAMN) and piperazine (Pip).

Advantageously, polyamide blocks PA 4.12, PA 4.14, PA 4.18, PA 6.10, PA 6.12, PA 6.14, PA 6.18, PA 9.12, PA 10.10, PA 10.12, PA 10.14 and PA 10.18 are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or from one or more lactams containing from 7 to 12 carbon atoms in the presence of a dicarboxylic acid containing from 4 to 12 carbon atoms or of a diamine.

Examples of lactams include enantholactam and lauryllactam. As examples of α,ω-aminocarboxylic acids, mention may be made of 7-aminoheptanoic acid, 11-aminoundecanoic acid and 12-aminododecanoic acid.

Advantageously, the polyamide blocks of the second type are blocks of PA 11 (polyundecanamide) or of PA 12 (polydodecanamide). In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
said comonomer(s) {Z} being introduced in a weight proportion advantageously ranging up to 50%, preferably up to 20%, even more advantageously up to 10% relative to the total amount of polyamide-precursor monomers;
in the presence of a chain limiter chosen from dicarboxylic acids.

Advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or from at least two lactams containing from 6 to 12 carbon atoms or from one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid and dimerized fatty acids. These dimerized fatty acids preferably have a dimer content of at least 98%; they are preferably hydrogenated; they are, for example, products sold under the brand name Pripol by the company Croda, or under the brand name Empol by the company BASF, or under the brand name Radiacid by the company Oleon, and polyoxyalkylene α,ω-diacids. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6.10/11/12, where 6.6 denotes hexamethylenediamine condensed with adipic acid, 6.10 denotes hexamethylenediamine condensed with sebacic acid, 11 denotes units resulting from the condensation of aminoundecanoic acid and 12 denotes units resulting from the condensation of lauryllactam;
PA 6/11 where 6 denotes units resulting from the condensation of caprolactam and 11 denotes units resulting from the condensation of aminoundecanoic acid;
PA 6/12 where 6 denotes units resulting from the condensation of caprolactam and 12 denotes units resulting from the condensation of lauryllactam;
PA 11/12 where 11 denotes units resulting from the condensation of aminoundecanoic acid and 12 denotes units resulting from the condensation of lauryllactam.

The notations PA X/Y, PA X/Y/Z, etc. relate to copolyamides in which X, Y, Z, etc. represent homopolyamide units as described above.

The repeating units of the polyamide blocks of the copolymer according to the invention have a mean carbon content of greater than or equal to 7.

The term “mean carbon content of the repeating units” means the mean of the numbers of carbon atoms of each repeating unit present in the polyamide blocks of the copolymer, weighted by the molar proportion of said repeating unit relative to the total amount of polyamide blocks. For example, for a PA X/Y as defined above comprising a mol % of PA X and b mol % of PA Y (a %+b % representing 100 mol % of the polyamide), the mean carbon content is: (a×x+b×Y)/100. When the polyamide blocks comprise a single repeating unit, as in the case of a block of PA X or of a block of PA X.Y as defined above, the mean carbon content of the repeating units of the polyamide blocks is equal to the number of carbon atoms of said repeating unit, given that a polyamide repeating unit contains, in a known manner, only one amide function. In the case of a PA X block, the number of carbon atoms of the repeating unit is X. In the case of a PA X.Y block, the number of carbon atoms of the repeating unit is (X+Y)/2 since the unit X.Y comprises two amide functions.

Advantageously, the polyamide blocks of the copolymer according to the invention comprise, or consist of, blocks of polyamide PA 11, PA 12, PA 5.4, PA 5.9, PA 5.10, PA 5.12, PA 5.13, PA 5.14, PA 5.16, PA 5.18, PA 5.36, PA 6.4, PA 6.9, PA 6.10, PA 6.12, PA 6.13, PA 6.14, PA 6.16, PA 6.18, PA 6.36, PA 10.4, PA 10.9, PA 10.10, PA 10.12, PA 10.13, PA 10.14, PA 10.16, PA 10.18, PA 10.36, PA 10.T, PA 12.4, PA 12.9, PA 12.10, PA 12.12, PA 12.13, PA 12.14, PA 12.16, PA 12.18, PA 12.36, PA 12.T, or mixtures or copolymers thereof.

Particularly preferably, the polyamide blocks of the copolymer comprise, or consist of, blocks of polyamide PA 11, PA 12, PA 6.10, PA 6.12, PA 10.10, PA 10.12, or of copolyamide PA 6/11, PA 6/12, PA 11/12, or mixtures or copolymers thereof.

Preferably, the mean carbon content of the repeating units of the polyamide blocks of the copolymer according to the invention is from 8 to 14, more preferentially from 8 to 12. In certain embodiments, this carbon content of the repeating units is from 7 to 8, or from 8 to 9, or from 9 to 10, or from 10 to 11, or from 11 to 12, or 12 to 13, or 13 to 14, or 14 to 15, or 15 to 18, or 18 to 22, or 22 to 25, or 25 to 30, or 30 to 40.

The flexible blocks of the copolymer are advantageously polyether blocks (the copolymer is then a PEBA or copolymer containing polyamide blocks and polyether blocks) or polyether and polyester blocks. The polyether blocks are formed from alkylene oxide units.

The flexible blocks of the copolymer according to the invention comprise blocks derived from polyethylene glycol (PEG). The mass proportion of blocks derived from polyethylene glycol in the copolymer is at least 35% relative to the total weight of the copolymer. Preferably, the copolymer according to the invention comprises at least 40% by weight of blocks derived from PEG, more preferably the copolymer comprises from 50% to 90% by weight of blocks derived from PEG, more preferentially from 60% to 80% by weight, relative to the total weight of the copolymer. In certain embodiments, the copolymer comprises 35 to 40%, or 40 to 45%, or 45 to 50%, or 50 to 55%, or 55 to 60%, or 60 to 65%, or from 65% to 70% by weight, or from 70% to 75% by weight, or from 75% to 80%, or from 80% to 85%, or from 85% to 90%, by weight, of blocks derived from PEG, relative to the total weight of the copolymer.

In certain embodiments, the flexible blocks of the copolymer according to the invention consist of blocks derived from PEG.

Alternatively, the flexible blocks of the copolymer may contain at least one other block in addition to the blocks derived from PEG.

The flexible blocks of the copolymer may also comprise, in addition to the blocks derived from PEG, one or more other polyethers and/or polyesters and/or polysiloxanes and/or polydimethylsiloxanes (or PDMS) and/or polyolefins and/or polycarbonates. Possible flexible blocks are described, for example, in French patent application FR 2941700 A1, from page 32 line 3 to page 33 line 8, from page 34 line 16 to page 37 line 13 and on page 38 lines 6 to 23.

Preferably, this other block is a polyether block other than a block derived from PEG and/or a polyester block.

The copolymers may comprise in their chain several types of polyethers other than a block derived from PEG, the corresponding copolyethers possibly being block or random copolyethers.

As polyether blocks other than a block derived from PEG, which are suitable for the invention, mention may be made of blocks derived from PPG (polypropylene glycol) consisting of propylene oxide units, blocks derived from PO3G (polytrimethylene glycol) consisting of polytrimethylene glycol ether units and blocks derived from PTMG (polytetramethylene glycol) consisting of tetramethylene glycol units, also called polytetrahydrofuran, or any combination thereof. Particularly preferably, the polyether block is a block derived from polypropylene glycol and/or from polytetrahydrofuran.

It is also possible to use, as polyether other than PEG, blocks obtained by oxyethylation of bisphenols, for instance bisphenol A. These latter products are notably described in EP 613919.

The polyether blocks may also consist of ethoxylated primary amines. As examples of ethoxylated primary amines, mention may be made of the products of formula:

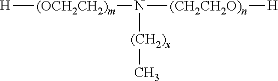

in which m and n are integers between 1 and 20 and x is an integer between 8 and 18. These products are commercially available, for example, under the brand name Noramox® from the company CECA and under the brand name Genamin® from the company Clariant.

The flexible blocks may comprise polyoxyalkylene polyether blocks bearing NH₂ chain ends, such blocks being obtainable by cyanoacetylation of aliphatic α,ω-dihydroxylated polyoxyalkylene blocks known as polyetherdiols. More particularly, the commercial products Jeffamine or Elastamine may be used (for example Jeffamine® D400, D2000, ED 2003, XTJ 542, which are commercial products from the company Huntsman, also described in JP 2004/346274, JP 2004/352794 and EP 1482011).

The polyether diol blocks are either used in unmodified form and copolycondensed with rigid blocks bearing carboxylic end groups, or are aminated to be converted into polyetherdiamines and condensed with rigid blocks bearing carboxylic end groups.

The copolymers according to the present invention include copolymers comprising three, four (or even more) different blocks chosen from those described in the present description, since these blocks include at least polyamide blocks and blocks derived from polyethylene glycol.

For example, the copolymer according to the invention may be a segmented block copolymer comprising three different types of blocks (or “triblock” copolymer), which results from the condensation of several of the blocks described above. Said triblock may be, for example, a copolymer comprising a polyamide block, a polyester block and a block derived from PEG or a copolymer comprising a polyamide block and two different polyether blocks, for example a block derived from PEG and a block derived from PTMG.

In a particularly advantageous manner, the copolymers according to the invention comprise, or consist of, blocks of PA 11, PA 12, PA 6, derived from PEG, derived from PTMG or any mixture or combination thereof, provided that the mean carbon content of the repeating units of the polyamide blocks of the copolymer is greater than or equal to 7 and that the copolymer comprises at least 35% by weight of blocks derived from polyethylene glycol.

Copolymers that are particularly preferred in the context of the invention are copolymers including blocks (or consisting of blocks):
PA 11 and derived from PEG;
PA 11, derived from PEG and derived from PTMG
PA 12 and derived from PEG;
PA 12, derived from PEG and derived from PTMG;
PA 6/11 and derived from PEG;
PA 6/11 and derived from PEG and derived from PTMG;
PA 6.10 and derived from PEG;
PA 6.10 and derived from PEG and derived from PTMG;
PA 6/12 and derived from PEG;
PA 6/12 and derived from PEG and derived from PTMG.

The number-average molar mass of the rigid polyamide blocks in the copolymer according to the invention is preferably from 400 to 20 000 g/mol, more preferentially from 500 to 10 000 g/mol, even more preferentially from 600 to 6000 g/mol. In certain embodiments, the number-average molar mass of the rigid polyamide blocks in the copolymer is from 400 to 500 g/mol, or from 500 to 1000 g/mol, or from 1000 to 1500 g/mol, or from 1500 to 2000 g/mol, or 2000 to 2500 g/mol, or 2500 to 3000 g/mol, or 3000 to 3500 g/mol, or 3500 to 4000 g/mol, or 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the flexible blocks is preferably from 100 to 6000 g/mol, more preferentially from 200 to 3000 g/mol. In certain embodiments, the number-average molar mass of the flexible blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol. The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of limiter (for example diacid) in excess, MW_{repeating unit} represents the molar mass of the repeating unit, and MW_{chain limiter} represents the molar mass of the limiter (for example diacid) in excess. The number-average molar mass of the rigid blocks and of the flexible blocks can be measured before the copolymerization of the blocks by gel permeation chromatography (GPC). The number-average molar mass of the polyol blocks may be determined by measuring the hydroxyl number.

The copolymer according to the invention may be a linear or branched copolymer. For example, the copolymer may be a branched copolymer in which the branchings are made by a polyol residue with a functionality of greater than 2 (i.e. the polyol includes at least three hydroxyl groups) bonding polyamide rigid blocks of the copolymer.

The copolymer according to the invention comprises from 55% to 90% by weight of flexible blocks and from 10% to 45% by weight of rigid polyamide blocks, relative to the total weight of the copolymer. The mass proportions of the flexible blocks and of the rigid blocks in the copolymer may be determined by DSC (differential scanning calorimetry). Advantageously, the copolymer comprises from 60% to 90% by weight of flexible blocks and from 10% to 40% by weight of rigid polyamide blocks, relative to the total weight of the copolymer.

The copolymer may comprise, relative to the total weight of the copolymer, from 55% to 60% by weight of flexible blocks and from 40% to 45% by weight of rigid polyamide blocks; or from 60% to 65% by weight of flexible blocks and from 35% to 40% by weight of rigid polyamide blocks; or from 65% to 70% by weight of flexible blocks and from 30% to 35% by weight of rigid polyamide blocks; or from 70% to 75% by weight of flexible blocks and from 25% to 30% by weight of rigid polyamide blocks; or from 75% to 80% by weight of flexible blocks and from 20% to 25% by weight of rigid polyamide blocks; or from 80% to 85% by weight of flexible blocks and from 15% to 20% by weight of rigid polyamide blocks; or from 85% to 90% by weight of flexible blocks and from 10% to 15% by weight of rigid polyamide blocks.

In certain embodiments, the copolymer consists essentially or consists of the proportions of flexible blocks and rigid blocks polyamides indicated above. Advantageously, the copolymer according to the invention has, in the water-saturated state (that is to say at water saturation), an elongation at break of greater than or equal to 100%. Preferably, the copolymer has, in the water-saturated state, an elongation at break of greater than or equal to 150%, more preferentially greater than or equal to 200%, even more preferentially greater than or equal to 250%, even more preferentially greater than or equal at 300%, even more preferentially greater than or equal to 350%. The elongation at break in the water-saturated state may be measured according to the standard ISO 527 1 BA: 2012.

The term “water-saturated state” or “with water saturation” means the state in which the water uptake of the copolymer is maximal (the copolymer cannot take up additional water). This water-saturated state may be achieved by placing a sample of copolymer immersed in water and performing regular measurements of the mass of the sample: the water-saturated state is reached when the mass of the sample is stabilized (it no longer varies).

Preferably, the copolymer according to the invention has an elongation at break in the dry state greater than or equal to 400%, preferably greater than or equal to 450%, more preferentially greater than or equal to 500%, even more preferentially greater than or equal to 550%, even more preferentially greater than or equal to 600%. The elongation at break in the dry state may be measured according to the standard ISO 527 1 BA: 2012.

The copolymer according to the invention preferably has a tensile stress in the water-saturated state of greater than or equal to 1 MPa, preferably greater than or equal to 2 MPa, more preferentially greater than or equal to 3 MPa, even more preferentially greater than or equal to 4 MPa. The tensile stress in the water-saturated state may be measured according to the standard ISO 527 1 BA: 2012.

The copolymer according to the invention preferably has a tensile stress in the dry state of greater than or equal to 10 MPa, preferably greater than or equal to 12 MPa, more preferentially greater than or equal to 15 MPa. The tensile stress in the dry state may be measured according to the standard ISO 527 1 BA: 2012.

Advantageously, the copolymer according to the invention has an absorption of water to saturation at 23° C. of from 50% to 160% by weight relative to the weight of the copolymer, preferably from 50% to 150% by weight, for example from 50% to 100% by weight, or 100% to 125% by weight, or 125% to 150% by weight, or 150% to 160% by weight. The water absorption to saturation at 23° C. of the copolymer may be determined according to the standard ISO 62: 2008.

### Synthesis of the Copolymer

The invention also relates to a process for preparing the copolymer as described above.

In a general and known manner, the polymers containing rigid polyamide blocks and flexible blocks may be prepared according to a “two-step” preparation process (comprising a first step of synthesis of the polyamide blocks then a second step of condensation of the polyamide blocks and the flexible blocks) or by a “one-step” preparation process.

In certain embodiments, the copolymer is prepared according to a two-step process. This process comprises the following steps:
the synthesis of the rigid polyamide blocks from polyamide precursors;
the addition of the flexible blocks;
condensation of the rigid polyamide blocks and of the flexible blocks.

Alternatively, the copolymer according to the invention may be prepared according to a one-step process, involving mixing the flexible blocks with polyamide precursors and a chain-limiting diacid.

The general method for the two-step preparation (that is to say, a first step of synthesis of the polyamide blocks then a second step of condensation of the polyamide and polyether blocks) of the copolymers containing polyamide blocks and polyether blocks (also called PEBA according to the IUPAC, or polyether-block-amide) bearing ester bonds between the PA blocks and the PE blocks is known and described, for example, in FR 2846332. The general method for preparing PEBA copolymers bearing amide bonds between the PA blocks and the PE blocks is known and described, for example in EP 1482011. The polyether blocks may also be mixed with polyamide precursors and a chain-limiting diacid to prepare polymers containing polyamide blocks and polyether blocks having randomly distributed units (one-step process).

Irrespective of the preparation method (in one or two steps), the copolymers bearing polyamide rigid blocks and flexible blocks result from the polycondensation of polyamide blocks bearing reactive ends with flexible blocks bearing reactive ends, such as, inter alia, the polycondensation of:

1) polyamide blocks bearing diamine chain ends with flexible blocks bearing dicarboxylic chain ends;
2) polyamide blocks bearing dicarboxylic chain ends with flexible blocks bearing diamine chain ends, obtained, for example, by cyanoethylation and hydrogenation of aliphatic α,ω-dihydroxylated polyoxyalkylene blocks known as polyetherdiols;
3) of polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

When the copolymer is a branched copolymer, it may be prepared by adding, during its synthesis, one or more polyols including at least three hydroxyl groups as branching agent. In the one-step or two-step processes described above, the polyol is added with the polyamide precursors. Advantageously, the polyol is added in an amount ranging from 0.01% to 10% by weight, preferably from 0.01% to 5% by weight, more preferably from 0.05% to 0.5% by weight, relative to the total weight of polyol, polyamide precursors and flexible blocks. The addition of a polyol including at least three hydroxyl groups brings about bridging bonds connecting together the rigid polyamide blocks of the copolymer, preferably via ester bonds. The polyol may notably be:
a monomeric polyol, notably a monomeric aliphatic triol such as glycerol, trimethylolpropane, pentaerythritol, and/or
a polymer polyol, notably a triol containing polyether chains, a polycaprolactone triol, a mixed polyether-polyester polyol including at least three hydroxyl groups.

Advantageously, the polyol is chosen from: pentaerythritol, trimethylolpropane, trimethylolethane, hexanetriol, diglycerol, methylglucoside, tetraethanol, sorbitol, dipentaerythritol, cyclodextrin, polyether polyols including at least three hydroxyl groups, and mixtures thereof. The weight-average molar mass of the polyol is preferably not more than 3000 g/mol, more preferentially not more than 2000 g/mol.

### Membrane

The invention also relates to a membrane (or film) comprising a copolymer as described above.

The thickness of the membrane according to the invention is preferably from 0.05 to 100 μm. Particularly preferably, the thickness is from 0.5 to 50 μm.

The thickness of the membrane may be from 0.05 to 0.5 μm, or from 0.5 to 1 μm, or from 1 to 2 μm, or from 2 to 5 μm, or from 5 to 10 μm, or from 10 to 20 μm, or from 20 to 30 μm, or from 30 to 40 μm, or from 40 to 50 μm, or from 50 to 60 μm, or from 60 to 70 μm, or from 70 to 80 μm, or from 80 to 90 μm, or from 90 to 100 μm.

In certain embodiments, the membrane consists essentially of, or consists of, a copolymer as described above.

In other embodiments, the membrane according to the invention also comprises at least one additional polymer or oligomer chosen from polyolefins such as polyethylene, polypropylene, poly(3-methyl-1-butene) and poly(4-methyl-1-pentene); vinyl polymers such as polystyrene, poly(methyl methacrylate); polysulfones; fluorinated or chlorinated polymers such as poly(vinylidene fluoride), polytetrafluoroethylene, fluorovinylethylene/tetrafluoroethylene copolymers, polychloroprene; polyamides such as PA 6, PA 6.6 and PA 12; copolymers containing rigid blocks and flexible blocks, such as copolymers containing polyamide blocks and polyether blocks; polyesters such as polyethylene terephthalate, polybutene terephthalate and polyethylene-2,6-naphthalate; polycarbonates such as poly-4,4′-dihydroxydiphenyl-2,2-propane carbonate; polyethers such as polyoxymethylene and polymethylene sulfide; polyphenylene chalcogenides such as polythioether, polyphenylene oxide and polyphenylene sulfide; polyether ether ketones; polyether ketone ketones; silicones such as polyvinyltrimethylsiloxane, polydimethylsiloxane; perfluoroalkoxy; polyethylene glycol; ethylene-vinyl acetate (EVA); ethylene-methyl acrylate (EMA); ethylene-EBA (ethylene-butyl acrylate)-MAH (maleic anhydride), ethylene-EMA-MAH, ethylene-GMA (glycidyl methacrylate)-EBA, ethylene-EMA-GMA, ethylene-EVA-MAH terpolymers; and mixtures thereof.

Advantageously, the membrane comprises at least 50% by weight of copolymer containing rigid polyamide blocks and flexible blocks as described above and not more than 50% by weight of additional polymer or oligomer, relative to the total weight of the membrane.

The membrane may also comprise one or more additives chosen from the group consisting of UV stabilizers, crosslinking agents, pigments, metal oxides, zeolites and mixtures thereof, preferably in a mass amount of from 0.01% to 30% by weight relative to the total weight of the membrane.

The membrane according to the invention may be a composite membrane, that is to say a membrane comprising at least one polymer layer as described above, deposited on at least one porous, microporous or nanoporous support layer, such as nonwoven polypropylene or any polymeric framework.

Advantageously, the membrane is a waterproof-breathable membrane. The term “waterproof-breathable” means permeable to water vapor and impermeable to liquid water.

Preferably, the membrane according to the invention has a permeability to water vapor (MVTR, for “Moisture Vapor Transmission Rate”) of at least 800 g/m² per 24 hours, at 23° C., at a relative humidity of 50%, for a membrane thickness of 30 μm. More preferably, the permeability to water vapor MVTR of the membrane is at least 900 g/m²/24 h, more preferentially at least 1000 g/m²/24 h, even more preferentially from 1000 to 5000 g/m²/24 h, at 23° C., at a relative humidity of 50%, for a membrane thickness of 30 μm. In particular, the MVTR membrane permeability may range from 800 to 900 g/m²/24 hr, or from 900 to 1000 g/m²/24 hr, or from 1000 to 1200 g/m²/24 h or 1200 to 1500 g/m²/24 hr, or from 1500 to 2000 g/m²/24 h, or 2000 to 2500 g/m²/24 hr, or from 2500 to 3000 g/m²/24 h, or 3000 to 3500 g/m²/24 h, or 3500 to 4000 g/m²/24 hr, or from 4000 to 4500 g/m²/24 hr, or from 4500 to 5000 g/m²/24 h, at 23° C., at a relative humidity of 50%, for a membrane thickness of 30 μm. The permeability to water vapor (MVTR) of the membrane, at 23° C., for a relative humidity of 50%, for a membrane thickness of 30 μm, may be measured according to the standard ASTM E96 B.

The membrane according to the invention advantageously has a permeability to carbon dioxide CO₂TR (for “CO₂ transmission rate”) of greater than or equal to 100 000 cm³·25 mm/m²·24 h·atm, at 23° C., at a relative humidity of 0%. Preferably, the permeability of the membrane to carbon dioxide is greater than or equal to 120 000 cm³·25 μm/m²·24 h·atm, more preferentially greater than or equal to 150 000 cm³·25 μm/m²·24 h·atm, even more preferentially greater than or equal to 160 000 cm³·25 μm/m²·24 h·atm, even more preferentially greater than or equal to 180 000 cm³·25 μm/m²·24 h·atm, even more preferentially greater than or equal to 200 000 cm³·25 μm/m²·24 h·atm, at 23° C., at 0% relative humidity. The permeability of the membrane to carbon dioxide at 23° C., at a relative humidity of 0%, for a membrane thickness of 25 μm, may be determined according to the following method: in a permeation cell, the upper side of the film to be tested is flushed with the test gas and the stream which diffuses through the film in the lower part flushed with a carrier gas is analyzed by gas chromatography. The operating parameters are as follows:
Test gas: O₂/CO₂ gas mixture, in proportions of 80/20 mol %;
Permeameter device: LYSSY GPM 500 coupled with the detection device;
Detection device: gas chromatograph equipped with a TCD (thermal conductivity detector) referenced Agilent 4890D;
Gas syringe with a shut-off valve for chromatography (example: EMS syringe reference 008110/1 MR-V-GT);
Aluminum surface reducer;
Cryothermostats: one high power (2.4 kW) for the LYSSY GPM500 and two low power (1.8 kW) for the bubbler baths;
Test temperature: 23° C.;
Relative humidity: 0%.

The permeability to a gas is then calculated by the formula:

$$\frac{quantity . e}{area . time . ( p 1 - p 2 )}$$

where “quantity” is the volume of gas of interest (in this instance CO₂) which has passed through the film, “e” is the thickness of the film, “area” is the area of the film, “time” is the duration of the flushing with the test gas and p1 and p2 are the partial pressures on either side of the film, respectively upstream and downstream of the film.

The membrane according to the invention advantageously has a permeability to dioxygen (“oxygen transmission rate”, OTR) of less than or equal to 50 000 cm³·25 μm/m²·24 h·atm, at 23° C., at a relative humidity of 0%. Preferably, the permeability to dioxygen of the membrane is less than or equal to 40 000 cm³·25 μm/m²·24 h·atm, more preferentially less than or equal to 30 000 cm³·25 μm/m²·24 h·atm, even more preferentially less than or equal to 30 000 cm³·25 μm/m²·24 h·atm, even more preferentially less than or equal to 25 000 cm³·25 μm/m²·24 h·atm, even more preferentially less than or equal to 22 000 cm³·25 μm/m²·24 h·atm, even more preferentially less than or equal to 20 000 cm³·25 μm/m²·24 h·atm, at 23° C., at 0% relative humidity. The permeability of the membrane to dioxygen at 23° C., at a relative humidity of 0%, for a membrane thickness of 25 μm, may be determined according to the method described above in relation to the permeability to carbon dioxide (except that the gas of interest is O₂).

Advantageously, the membrane according to the invention has a carbon dioxide/dioxygen selectivity P_{CO2}/P_{O2} of greater than or equal to 10. The carbon dioxide/dioxygen selectivity of a membrane corresponds to the ratio of the permeability to carbon dioxide of said membrane to the permeability to dioxygen of said membrane, measured at a temperature of 23° C. and at 0% relative humidity. The permeabilities of the membrane to carbon dioxide and to dioxygen are determined under the same conditions and may be measured as described above. Preferably, the P_{CO2}/P_{O2} selectivity of the membrane is greater than or equal to 12, more preferentially greater than or equal to 13, even more preferentially greater than or equal to 14, even more preferentially greater or equal to 15. In other advantageous embodiments, it is greater than or equal to 16, or 17 or 18.

The invention also relates to the use of a copolymer as described above for the manufacture of a membrane. In certain embodiments, the membrane is a gas separation membrane, or a membrane for dehumidifying gases, for example air, or an enthalpy heat exchanger membrane, or a textile membrane. The membrane may also be a membrane for recovering greenhouse gases, in particular carbon dioxide and/or methane.

The membrane according to the invention may be prepared in a known manner by any melt process (for example, by flat film extrusion (“extrusion cast”) or by extrusion coating on a support) or in a solvent process (for example by deposition in the solvent/evaporation process (“solvent cast”)).

In particular, the membrane may be manufactured by a process comprising the following steps:
supplying a copolymer as described above;
dissolving the copolymer in a solvent;
depositing the polymer dissolved in the solvent on a substrate;
evaporating off the solvent.

Alternatively, the membrane may be manufactured by a process comprising the following steps:
supplying a copolymer as described above;
melting the copolymer;
forming a molten copolymer film;
solidifying the film.

When the membrane is a composite layer, the polymer layer may be deposited on the support layer by extrusion coating, extrusion lamination, adhesive lamination, deposition by solvent/evaporation (“solvent cast”), atomization (“spray coating”), welding or sealing.

### EXAMPLES

The examples that follow illustrate the invention without limiting it.

### Example 1

Membranes were prepared from various copolymers containing polyamide blocks and flexible blocks via a flat film extrusion process (“extrusion cast”) using an extruder having the following parameters:
screw diameter: 30 mm;
L/D ratio: 25
profile: screw-barrier;
die: T-shaped, 250 μm wide and 300 μm air gap.

The extrusion temperatures are between 180° C. and 230° C. and are adapted according to the guard of the copolymer.

The features of the copolymers and of the membranes are given in the following table:

TABLE 1

| | Copolymer composition | | |
|---|---|---|---|
| Membrane | | Proportions of the | Membrane |
| No. | Nature of the blocks | blocks (in mol %) | thickness (μm) |
| 1 | PA 12 and derived from PEG | 75/25 | 60 |
| 2 | PA 12 and derived from PEG | 50/50 | 60 |
| 3 | PA 6 and derived from PEG | 50/50 | 50 |
| 4 | PA 12 and derived from PTMG | 30/70 | 60 |
| 5 | PA 12 and derived from PTMG | 23/77 | 60 |
| 6 | PA 6 and derived from PEG | 40/60 | 50 |
| 7 | PA 11 and derived from PEG | 40/60 | 50 |
| 8 | PA 6/11 and derived from PEG | 20.7/15.8/63.5 | 80 |
| 9 | PA 12, derived from PEG and | 35/55/10 | 70 |
| | derived from PTMG | | |
| 10 | PA 12, derived from PEG and | 32.5/40.5/27 | 70 |
| | derived from PTMG | | |

The copolymer of membrane 8 was prepared from PEG diamine blocks. Membranes 7 to 10 are according to the invention and membranes 1 to 6 correspond to comparative examples.

These membranes were tested for various properties and the results are given below:

TABLE 2

| | | OTR | CO₂TR | |
|---|---|---|---|---|
| Membrane | MVTR | (cm³. 25 μm/ | (cm³. 25 μm/ | P_{CO2}/P_{O2} |
| No. | (g/m². 24 h) | m². 24 h. atm) | m². 24 h. atm) | selectivity |
| 1 | 470 | 3700 | 42 160 | 11.4 |
| 2 | 940 | 7100 | 90 000 | 12.6 |
| 3 | 1010 | 4000 | 65 600 | 16.4 |
| 4 | 515 | 40 290 | 328 980 | 8.2 |
| 5 | 530 | 50 670 | 391 380 | 7.7 |
| 6 | 1310 | 15 000 | 273 310 | 18.2 |
| 7 | 1085 | 14 500 | 263 000 | 18.1 |
| 8 | 980 | 10 550 | 163 000 | 15.4 |
| 9 | 900 | 21 730 | 264 230 | 12.2 |
| 10 | 1000 | 8800 | 171 000 | 19.4 |

The permeability to water vapor MVTR was measured at 23° C., at 50% relative humidity, according to the standard ASTM E96B.

The permeability to dioxygen OTR and the permeability to carbon dioxide CO₂TR were measured at 23° C., at a relative humidity level of 0%, according to the method described above in the description. The values indicated are the values normalized for a 25 μm film.

The P_{CO2}/P_{O2} selectivity was calculated by dividing the permeability CO₂TR by the permeability OTR.

It is observed that the membranes according to the invention (membranes 7 to 10) have both high permeability to water vapor, high permeability to CO₂ and good P_{CO2}/P_{O2} selectivity.

In comparison with the membranes according to the invention, membranes 1, 2 and 3 have a lower permeability to carbon dioxide. Membrane 1 also has low permeability to water vapor.

Membranes 4 and 5 have low permeability to water vapor and low P_{CO2}/P_{O2} selectivity.

Membrane 6 has insufficient mechanical properties in the water-saturated state, due to very high water uptake. There is a very marked decrease in the elongation at break and the tensile stress in the water-saturated state relative to these features measured in the dry state.

Several mechanical properties of the copolymer containing PA 12 blocks/blocks derived from PEG (50/50) from which membrane 2 was prepared (PEBA No. 2), of the copolymer containing PA 6 blocks/blocks derived from PEG (50/50) from which membrane 3 was prepared (PEBA No. 3) and of the copolymer containing PA 11 blocks/blocks derived from PEG (40/60) from which membrane 7 was prepared (PEBA No. 7) were also tested.

Films 50 μm thick were prepared from the three PEBAs as described above and tensile tests were performed on these films, before and after they were subjected to an MVTR measurement test. For the measurements taken after the MVTR measurement test, the films were left to air dry for a few minutes before the tensile tests.

Samples (3 per product) approximately 7 mm wide and 50 mm long were cut with a guillotine. The traction measurements were performed on these samples according to the standard ASTM-D 882, with a traction speed of 200 mm/min and a length between the jaws (LO) of 25 mm. The tensile stress and elongation at break were measured. These properties were determined in the longitudinal direction relative to the extrusion direction and in the transverse direction relative to the extrusion direction.

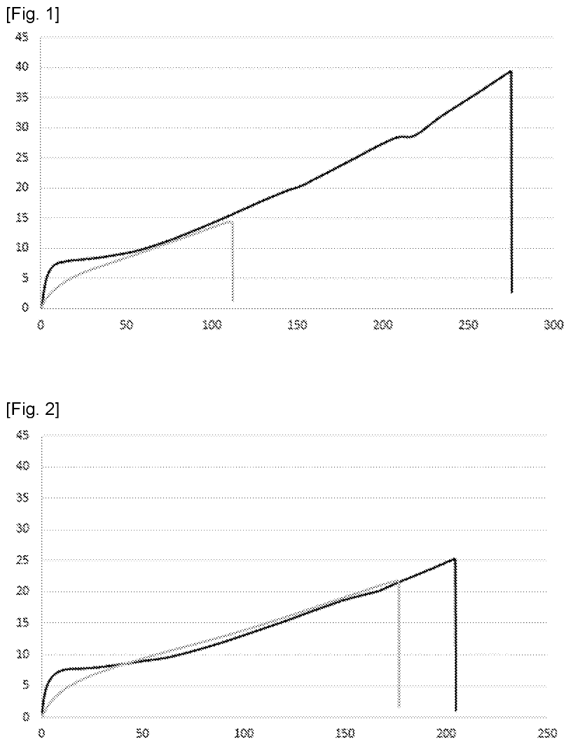

The results are shown in FIGS. 1 to 6.

As regards PEBA No. 3, in the transverse direction, there is a very strong reduction in the elongation at break and in the tensile stress after the MVTR measurement test relative to these features measured before the test (FIG. 1). In the longitudinal direction, a decrease in the elongation at break and in the tensile stress is also observed after the MVTR measurement test, although this is less pronounced than in the transverse direction (FIG. 2). PEBA No. 3 is thus sensitive to the MVTR measurement test, its mechanical properties were degraded following this test.

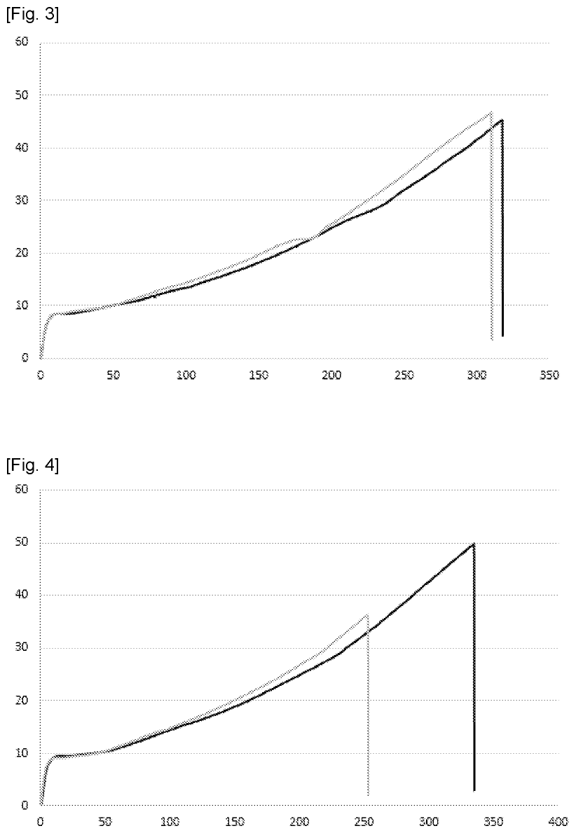

As regards PEBA No. 2, the polymer film has, after the MVTR measurement test, an elongation at break, in the transverse direction, similar to that obtained before the test (FIG. 3). However, in the longitudinal direction, the elongation at break and the tensile stress after the test are lower than those before the test (FIG. 4).

PEBA No. 2 shows relatively good resistance in the MVTR measurement test, but its permeability to carbon dioxide is too low as shown above.

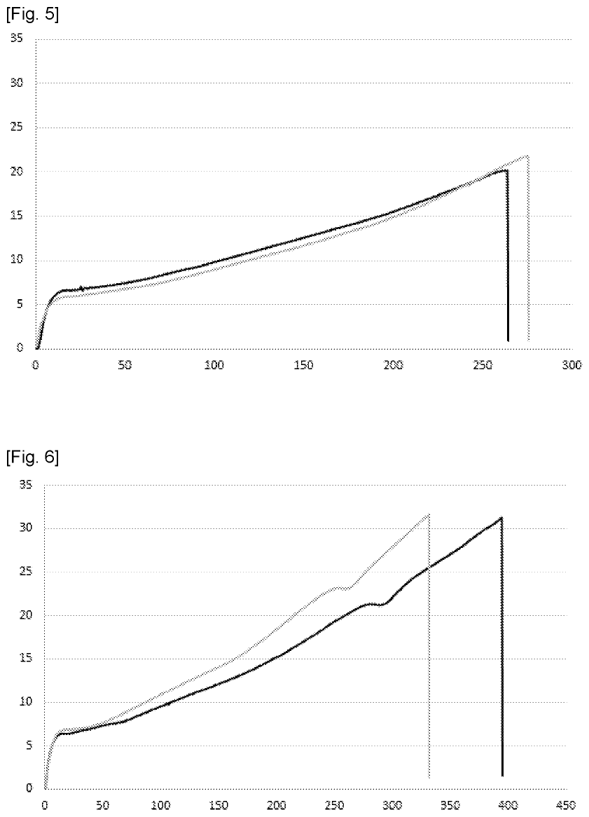

As regards PEBA No. 7, in the transverse direction, the film has similar mechanical properties before and after the MVTR measurement test, whether in terms of tensile stress or elongation at break (FIG. 5). In the longitudinal direction, the elongation at break measured after the MVTR measurement test decreased relative to that measured before the test (FIG. 6).

PEBA No. 7 shows good resistance in the MVTR measurement test and retains its mechanical properties after this test.

### Example 2

Branched copolymers were prepared according to a two-step process in which the polyamide blocks were first synthesized by mixing the polyamide precursors with a branching agent and the flexible blocks derived from PEG were then added and condensed with the polyamide blocks.

These copolymers have the following features:

TABLE 3

| PEBA | | Mn PA blocks (g/mol)/ | |
|---|---|---|---|
| No. | Nature of the blocks | Mn PE blocks (g/mol) | Branching agent/Mass amount |
| 11 | PA 6 and derived from PEG | 1000/1500 | Pentaerythritol/0.15% |
| 12 | PA 6 and derived from PEG | 1000/1500 | Pentaerythritol/0.15% |
| 13 | PA 6 and derived from PEG | 1000/1500 | Trimethylolpropane/0.15% |
| 14 | PA 6 and derived from PEG | 1000/1500 | Trimethylolpropane/0.3% |
| 15 | PA 6/11 and derived from PEG | 1000/1500 | Trimethylolpropane/0.15% |

The mass amount of the branching agent corresponds to the mass percentage of the branching agent, relative to the total weight of all the copolymer reagents, added with the polyamide precursors during the synthesis of the copolymers.

PEBA Nos 11, 12, 13 and 14 were prepared from PEG diamine blocks. In PEBA No. 15, the polyamide block comprises 70 mol % of PA 6 and 30 mol % of PA 11 and thus has a mean carbon content of the repeating units of 7.5.

PEBA No. 15 is a copolymer according to the invention, PEBA Nos 11 to 14 correspond to comparative examples.

The water absorption to saturation (or water uptake) at 23° C. of the copolymers and their mechanical properties, in the dry state and in the water-saturated state, were determined and are presented in the following table:

TABLE 4

| | | Tensile stress (MPa) | | Elongation at break (%) | |
|---|---|---|---|---|---|
| PEBA | Water uptake | | Water-saturated | | Water-saturated |
| No. | (weight %) | Dry state | state | Dry state | state |
| 11 | 200 | 21.9 | 0.4 | 668 | 16 |
| 12 | 160 | 20.6 | 1 | 737 | 33 |
| 13 | 192 | 22.7 | 0.6 | 663 | 32 |
| 14 | 197 | 21.2 | 0.3 | 671 | 16 |
| 15 | 150 | 15 | 4.3 | 680 | 396 |

The water uptake is measured according to the standard ISO 62: 2008. The tensile stress, in the dry state and in the water-saturated state, and the elongation at break, in the dry state and in the water-saturated state, were measured according to the standard ISO 527 1 BA: 2012.

The copolymers comprising a polyamide block having a mean carbon content of the repeating units equal to 6 (PEBA Nos 11 to 14) have a very high water uptake, and, consequently, a very low tensile stress and elongation at break when saturated with water. A membrane formed from these copolymers will thus have low durability.

In contrast, PEBA No. 15, which contains a polyamide block with a mean carbon content of the repeating units equal to 7.5, in the water-saturated state has a high elongation at break and a sufficient tensile stress.

The copolymers according to the invention have both good permeability to water vapor and to carbon dioxide, good P_{CO2}/P_{O2} selectivity and good mechanical properties, in the dry state and in the wet state.

1. A copolymer containing rigid polyamides blocks and flexible blocks comprising, relative to the total weight of the copolymer:
from 55% to 90% by weight of flexible blocks, including at least 35% by weight from polyethylene glycol;
from 10% to 45% by weight of rigid polyamide blocks, in which the mean carbon content of the repeating units of said polyamide blocks is greater than or equal to 7.

2. The copolymer as claimed in claim 1, in which the flexible blocks are polyether blocks and/or polyether and polyester blocks.

3. The copolymer as claimed in claim 14, in which the flexible blocks are blocks derived from polyethylene glycol or comprise, in addition to blocks derived from polyethylene glycol, blocks derived from another polyether, such as polytetrahydrofuran and/or propylene glycol, and/or polyester.

4. The copolymer as claimed in claim 1, in which the mean carbon content of the repeating units of the polyamide blocks is from 8 to 14.

5. The copolymer as claimed claim 1, in which the rigid polyamide blocks are blocks of polyamide 11, polyamide 12, polyamide 6.10, polyamide 6.12, polyamide 10.10, polyamide 10.12, copolyamide 6/11, copolyamide 6/12, copolyamide 11/12 or mixtures, or copolymers, thereof.

6. The copolymer as claimed claim 1, comprising from 60% to 90% by weight of flexible blocks and from 10% to 40% by weight of rigid polyamide blocks, relative to the total weight of the copolymer.

7. The copolymer as claimed in claim 1, comprising at least 40% by weight of flexible blocks derived from polyethylene glycol, relative to the total weight of the copolymer.

8. The copolymer as claimed in claim 1, said copolymer being a copolymer containing polyamide 11 blocks and blocks derived from polyethylene glycol, a copolymer containing polyamide 11 blocks and blocks derived from polyethylene glycol and blocks derived from polytetrahydrofuran, a copolymer containing polyamide 12 blocks and blocks derived from polyethylene glycol, a copolymer containing polyamide 12 blocks and blocks derived from polyethylene glycol and blocks derived from polytetrahydrofuran, a copolymer containing copolyamide 6/11 blocks and blocks derived from polyethylene glycol or a copolymer containing copolyamide 6/11 blocks and blocks derived from polyethylene glycol and blocks derived from polytetrahydrofuran.

9. The copolymer as claimed in claim 1, having an elongation at break in the water-saturated state of greater than or equal to 100%, and/or a water absorption to saturation at 23° C. ranging from 50% to 160% by weight, relative to the total weight of the copolymer.

10. A membrane comprising a copolymer as claimed claim 1, said membrane preferably being waterproof-breathable.

11. The membrane as claimed in claim 10, having a selectivity, defined as the ratio of its permeability to carbon dioxide to its permeability to dioxygen, measured at a temperature of 23° C. and at 0% relative humidity, of greater than or equal to 10.

12. The membrane as claimed in claim 10, having a permeability to water vapor MVTR of at least 800 g/m2, per 24 hours, at 23° C., for a relative humidity level of 50% and a membrane thickness of 30 μm.

13. The membrane as claimed in claim 10, having a thickness of from 0.05 to 100 μm.

14. The membrane as claimed in claim 10, also comprising at least one polymer or oligomer chosen from polyolefins; vinyl polymers; polysulfones; fluorinated or chlorinated polymers; polyamides; copolymers containing rigid blocks and flexible blocks; polyesters; polycarbonates; polyethers; polyphenylene chalcogenides; polyether ether ketones; polyether ketone ketones; silicones; polyethylene glycol; ethylene-vinyl acetate; ethylene-methyl acrylate; ethylene-(ethylene-butyl acrylate)-maleic anhydride, ethylene-(ethylene-methyl acrylate)-maleic anhydride, ethylene-glycidyl methacrylate-(ethylene-butyl acrylate), ethylene-(ethylene-methyl acrylate)-glycidyl methacrylate, ethylene-(ethylene-vinyl acetate)-maleic anhydride terpolymers; and mixtures thereof.

15. The use of a copolymer as claimed in claim 1, for the manufacture of a gas separation membrane, or of a membrane for dehumidifying gases, or of an enthalpy heat exchanger membrane, or of a textile membrane.

16. A process for preparing a copolymer as claimed in claim 1, comprising the following steps:
the synthesis of the rigid polyamide blocks from polyamide precursors;
the addition of the flexible blocks;
condensation of the rigid polyamide blocks and of the flexible blocks.

17. A process for preparing a copolymer as claimed in claim 1, involving mixing the flexible blocks with polyamide precursors and a chain-limiting diacid.

18. A process for manufacturing a membrane as claimed in claim 10, comprising the following steps:
supplying the copolymer;
dissolving the copolymer in a solvent;
depositing the polymer dissolved in the solvent on a substrate;
evaporating off the solvent.

19. A process for manufacturing a membrane as claimed in claim 10, comprising the following steps:
supplying the copolymer;
melting the copolymer;
forming a molten copolymer film;
solidifying the film.
